(19) United States
(12) Patent Application Publication
(10) Pub. No.: US 2018/0335827 A1
(43) Pub. Date: Nov. 22, 2018

(54) APPARATUS AND METHOD TO CONTROL POWER-SUPPLY TO A MEMORY BASED ON DATA-ACCESS STATES OF INDIVIDUAL MEMORY BLOCKS INCLUDED THEREIN

(71) Applicant: FUJITSU LIMITED, Kawasaki-shi (JP)

(72) Inventors: Noboru Ishiwata, Sagamihara (JP); Tomoyuki Kanayama, Kawasaki (JP); Yuzo KORI, Kawasaki (JP); Tomoharu Muro, Kawasaki (JP)

(73) Assignee: FUJITSU LIMITED, Kawasaki-shi (JP)

(21) Appl. No.: 15/980,308

(22) Filed: May 15, 2018

(30) Foreign Application Priority Data
May 19, 2017 (JP) 2017-100004

(51) Int. Cl. G06F 1/32; G06F 3/06

(52) U.S. Cl. CPC G06F 1/3268; G06F 1/3275; G06F 1/3287; G06F 3/0626

(57) ABSTRACT

An apparatus includes a memory configured to store target data including a data main-body and management information relating to the data main-body. The apparatus controls on and off of power supply to the memory in units of a power-supply block that is a memory block for storing a piece of data included in the data main-body or included in the management information. The apparatus turns off power supply to plural power-supply blocks in the memory, each of which stores a piece of data included in the data main-body. When a first access to the management information occurs, based on position information included in the management information, the apparatus turns on power supply to a first power-supply block that is a memory block storing a piece of data included in the data main-body which is to be accessed in connection with the first access.

### CROSS-REFERENCE TO RELATED APPLICATION

This application is based upon and claims the benefit of priority of the prior Japanese Patent Application No. 2017-100004, filed on May 19, 2017, the entire contents of which are incorporated herein by reference.

### FIELD

The embodiments discussed herein are related to apparatus and method to control power-supply to a memory based on data-access states of individual memory blocks included therein.

### BACKGROUND

In a storage apparatus, a solid state drive (SSD) is sometimes used in place of a hard disk drive (HDD) in a recording apparatus used for storage of data.

The SSD is high in data access performance in comparison with the HDD, and the number of SSDs that are incorporated in a storage apparatus is increasing with increase in the data amount treated in the storage apparatus.

A related technology is disclosed in Japanese Laid-open Patent Publication No. 2010-55287, Japanese Laid-open Patent Publication No. 2014-29638 or Japanese National Publication of International Patent Application No. 2003-536195.

### SUMMARY

According to an aspect of the invention, an apparatus includes a memory configured to store target data including a data main body and management information relating to the data main body. The apparatus controls on and off of power supply to the memory in units of a power-supply block that is a memory block for storing a piece of data included in the data main body or included in the management information. The apparatus turns off power supply to a plurality of power-supply blocks in the memory, each of which stores a piece of data included in the data main body. When a first access to the management information stored in the memory occurs, the apparatus turns on power supply to a first power-supply block of the plurality of power-supply blocks in the memory, based on position information included in the management information, where the first power-supply block is a memory block that stores a piece of data included in the data main body which is to be accessed in connection with the first access.

This object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a view schematically depicting a configuration of an SSD as an example of a first embodiment;

FIG. 2 is a view illustrating power supply control of a NAND cell in an SSD as an example of the first embodiment;

FIG. 3 is a view depicting an overview of processing upon data accessing in an SSD as an example of the first embodiment;

FIG. 4 is a view illustrating a state of use of a flash memory in an SSD as an example of the first embodiment;

FIG. 5 is a view exemplifying metadata in a logical volume in an SSD as an example of the first embodiment;

FIG. 6 is a view depicting a functional configuration of a memory controller in an SSD as an example of the first embodiment;

FIG. 7 is a view illustrating transition of a power supply state of a NAND cell in a read process of an SSD as an example of the first embodiment;

FIG. 8 is a sequence diagram illustrating a read process of an SSD as an example of the first embodiment;

FIG. 9 is a view illustrating transition of a power supply state of a NAND cell in a write process of an SSD as an example of the first embodiment;

FIG. 10 is a sequence diagram illustrating a write process of an SSD as an example of the first embodiment;

FIG. 11 is a view depicting an overview of processing upon data accessing in an SSD as an example of a second embodiment;

FIG. 12 is a view illustrating transition of a power supply state of a NAND cell in a read process of an SSD as an example of the second embodiment;

FIG. 13 is a sequence diagram illustrating a read process of an SSD as an example of the second embodiment;

FIG. 14 is a view illustrating transition of a power supply state of a NAND cell in a write process of an SSD as an example of the second embodiment; and

FIG. 15 is a sequence diagram illustrating a write process of an SSD as an example of the second embodiment.

### DESCRIPTION OF EMBODIMENTS

In a storage apparatus, it is demanded to reduce the power consumption. In recent years, it is tried to suppress the number of SSDs incorporated in a storage apparatus to achieve reduction of the power consumption by using such a technology as thin provisioning, deduplication, or data compression. However, power saving is demanded also for the SSD itself.

In one aspect, the embodiments discussed herein contemplate reduction of the power consumption of a memory.

In the following, embodiments of the storage apparatus and the control method are described with reference to the drawings. It is to be noted, however, that the embodiments described in the following are mere exemplifications to the end, and there is no intention to exclude application of various modifications and technologies not specified by the embodiments. For example, the embodiments may be carried out in various modified forms (by combination of the embodiments and/or modifications or the like) without departing from the spirit and scope thereof. Further, each figure is not intended to depict all related components and may include other functions and so forth.

### (I) Description of First Embodiment

(A) Configuration

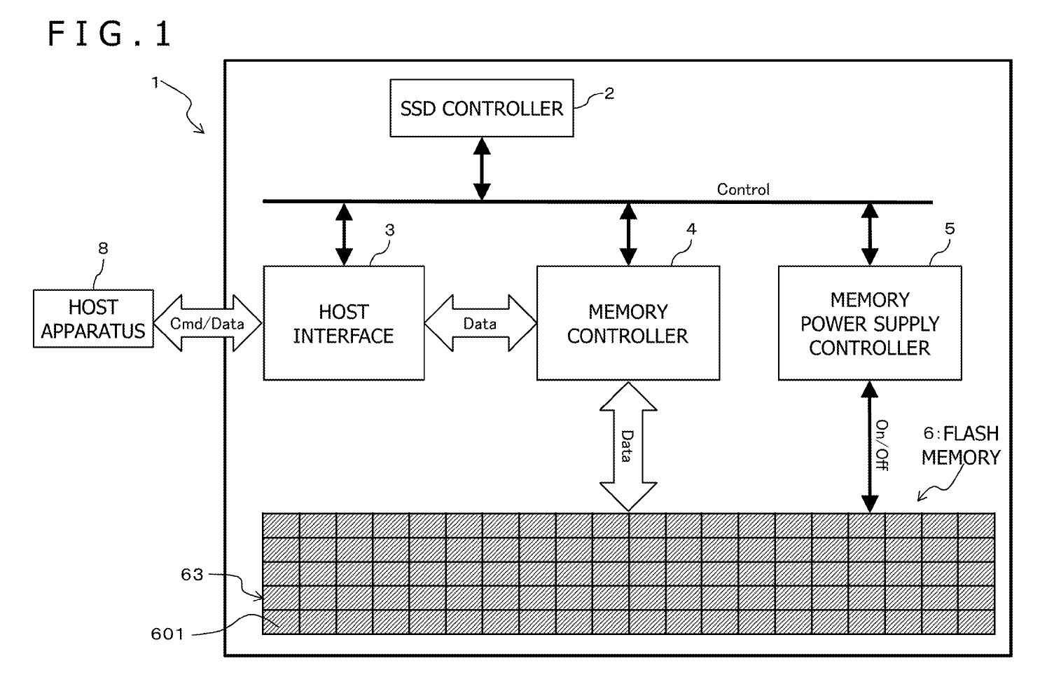

FIG. 1 is a view schematically depicting a configuration of an SSD as an example of a first embodiment.

An SSD 1 of the first embodiment is coupled to a host apparatus 8 and provides a storage region to the host apparatus 8.

The host apparatus 8 is an information processing apparatus that includes a processor, a memory and a storage apparatus not depicted and issues a read command for requesting read of data or a write command for requesting write of data to the SSD 1. In the following, any of the read request and the write request is sometimes referred to as input/output (I/O) request or I/O command.

Further, in the first embodiment, the host apparatus 8 has a function for issuing an I/O command with power supply control to the SSD 1. The SSD 1 that receives the I/O command with power supply control performs a data access process that involves power supply control for reducing the power consumption in a NAND cell 63.

The I/O command with power supply control is implemented, for example, by adding identification information such as a flag to a conventional I/O command.

Further, the host apparatus 8 may issue an I/O command to which the identification information is not added, for example, an I/O command of the conventional type, and in the case where the SSD 1 receives such an I/O command of the conventional type as just described, it performs processing similar to that performed by a conventional SSD.

In the following description, the term I/O command or I/O request refers to the I/O command with power supply control.

The SSD 1 performs a process of read or write of data in accordance with the I/O request from the host apparatus 8 and issues a response of a result of the process to the host apparatus 8.

As depicted in FIG. 1, the SSD 1 includes an SSD controller 2, a host interface 3, a memory controller 4, a memory power supply controller 5 and a flash memory 6.

The flash memory 6 is a semiconductor storage apparatus that readably and writably stores data, and data and so forth are stored into the flash memory 6. The embodiment indicates an example in which a NAND type flash memory including the NAND cell 63 is used as the flash memory 6.

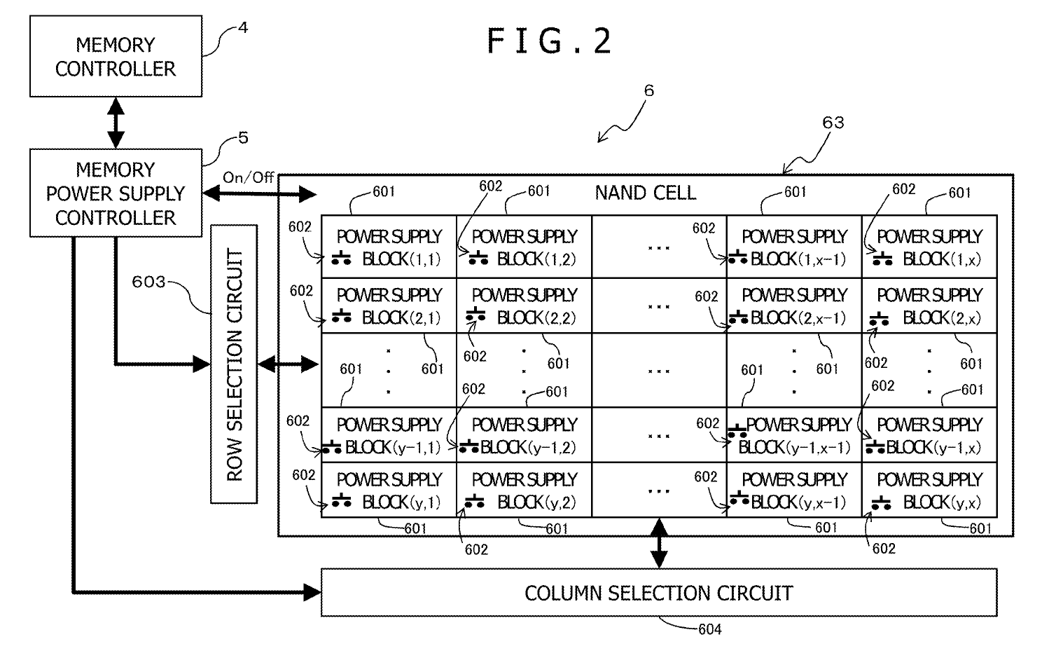

FIG. 2 is a view illustrating power supply control of a NAND cell in an SSD as an example of the first embodiment. The NAND cell and the SSD described with reference to FIG. 2 may be the NAND cell 63 and the SSD 1 described with reference to FIG. 1.

In the flash memory 6 provided in the SSD 1 of the first embodiment, the NAND cell (semiconductor storage region) 63 that is a data storage region is partitioned into a plurality of portions in a vertical direction (y direction) and a horizontal direction (x direction) each to form a plurality of power supply blocks 601 in a matrix. It may be considered that the storage region of the NAND cell 63 is partitioned (divided) into units of power supply blocks 601.

A power supply switch 602 is provided for each of the power supply blocks 601 such that, by switching the power supply switch 602 between on and off, the power supply to the power supply block 601 in which the power supply switch 602 is provided is switched between on and off. For example, in the flash memory 6, the power supply may be switched arbitrarily between on and off in a unit of a power supply block 601 by controlling the corresponding power supply switch 602.

It is to be noted that the size of the power supply blocks 601 may be suitably changed. Further, the size of the power supply blocks 601 may be set arbitrarily by a user.

The flash memory 6 further includes a row selection circuit 603 and a column selection circuit 604. The row selection circuit 603 selects power supply switches 602 (power supply blocks 601) in the vertical direction (y direction) of the NAND cell 63 in response to a selection signal inputted from the memory power supply controller 5 hereinafter described.

The column selection circuit 604 selects power supply switches 602 (power supply blocks 601) in the horizontal direction (x direction) of the NAND cell 63 in response to a selection signal inputted from the memory power supply controller 5.

The memory power supply controller 5 controls the power supply to the NAND cell 63. The memory power supply controller 5 controls the power supply between on and off in a unit of a power supply block 601 by switching the power supply switch 602 of each power supply block 601 between on and off in the NAND cell 63.

In the following, that the memory power supply controller 5 controls the power supply to a power supply block 601 between on and off by switching the power supply switch 602 of the power supply block 601 between on and off is sometimes referred to merely as to control (switch) the power supply to the power supply block 601 between on and off.

The memory power supply controller 5 combines selection of a power supply block 601 in the vertical direction (y direction) in the NAND cell 63 through the row selection circuit 603 and selection of a power supply block 601 in the horizontal direction (x direction) in the NAND cell 63 through the column selection circuit 604. Consequently, the memory power supply controller 5 selects one power supply block 601 in the NAND cell 63 and controls the power supply to the selected power supply block 601 between on and off.

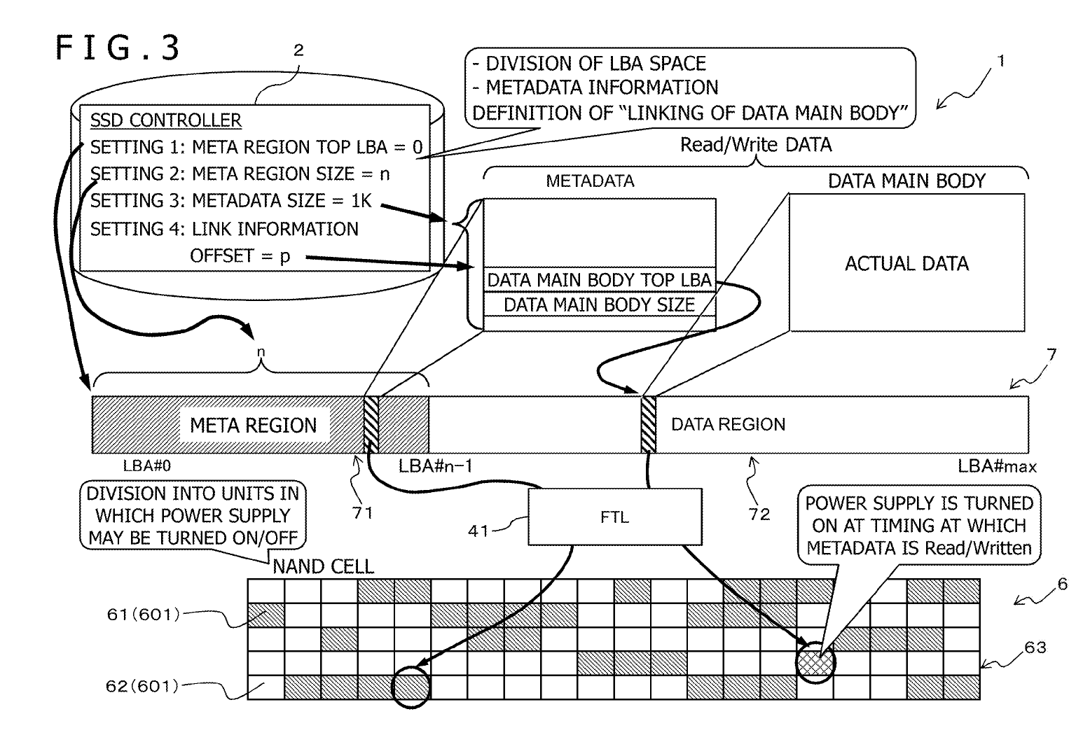

The storage region (physical memory region) of the NAND cell 63 is used for configuration of a logical volume 7 (refer to FIG. 3) that is a continuum of logical blocks by the virtualization technology, and this logical volume 7 is provided to an upper apparatus such as the host apparatus 8. Data configuring the logical volume 7 may be stored at distributed positions in the NAND cell 63. The logical volume 7 is sometimes referred to as logical block addressing (LBA) space.

The correspondence between a position (logical address or virtual address) in the LBA space and a position (physical address) in the NAND cell 63 is performed by a flash translation layer (FTL) 41 (refer to FIG. 3) hereinafter described. The range of virtual addresses is sometimes referred to as virtual address space, and the range of physical addresses is sometimes referred to as physical address space.

The data stored in the SSD 1 in the first embodiment include metadata and a data main body (actual data), and the SSD 1 manages the data separately for the metadata and the data main body.

The metadata is management information for managing the data main body and includes information of a data attribute, the number of times of reference and so forth. Further, in the SSD 1, the metadata includes logical storage position information indicative of a storage position of the data main body in the logical volume 7. The logical storage position information is, for example, a data main body top LBA indicative of the storage position of a top portion of the data main body in the logical volume 7 and a data main body size.

FIG. 3 is a view depicting an overview of processing upon data access in an SSD as an example of the first embodiment. The SSD described with reference to FIG. 3 may be the SSD 1 described with reference to FIG. 1.

The logical volume 7 includes a data region 72 for storing a data main body and a meta region 71 for storing metadata.

In the logical volume 7 depicted in FIG. 3, the top position of the meta region 71 is LBA#0, and the meta region 71 has a data size of n (unit: for example, Kbyte). For example, the region of LBA#0 to LBA#n−1 in the LBA space is the meta region 71. The meta region 71 is followed by the data region 72.

The top position (meta region top LBA) of the meta region 71 in each logical volume 7 or the size (meta region size) of the meta region 71 are set (stored) in advance as set values in the SSD controller 2 hereinafter described.

The logical volume 7 is configured by combining a plurality of storage regions of the NAND cell 63. Also the meta region 71 and the data region 72 are each configured by combining storage regions of the NAND cell 63.

Here, in the NAND cell 63, it is preferable for one power supply block 601 not to include a portion configuring the meta region 71 and a portion configuring the data region 72 in a mixed manner. In the SSD 1, it is assumed that each power supply block 601 is used as one of the meta region 71 and the data region 72.

For example, the power supply blocks 601 configuring the NAND cell 63 are classified into power supply blocks 601 that configure the meta regions 71 and power supply blocks 601 that configure the data regions 72.

In the following, a power supply block 601 configuring a meta region 71 from among a plurality of power supply blocks 601 that configure the NAND cell 63 is sometimes referred to as meta power supply block 61. Meanwhile, a power supply block 601 that configure a data region 72 from among the plurality of power supply blocks 601 that configure the NAND cell 63 is sometimes referred to as data power supply block 62.

In the example depicted in FIG. 3, in the NAND cell 63, each meta power supply block 61 is indicated by slanting lines while each data power supply block 62 is represented by a blank quadrangle.

In the present SSD 1, to the meta power supply blocks 61 from among the plurality of power supply blocks 601 that configure the NAND cell 63, power is normally supplied from the memory power supply controller 5 (powered on normally). In contrast, to the data power supply blocks 62 from among the plurality of power supply blocks 601 that configure the NAND cell 63, power supply is basically stopped (suppressed) (powered off normally) but is temporarily made available in the case where data access occurs to the data region 72 of the logical volume 7. Details of such power supply control to the NAND cell 63 are hereinafter described.

In the following description, to supply power to a power supply block 601 is sometimes referred to as to “turn on the power supply,” and to stop the power supply to the power supply block 601 is sometimes referred to as to “turn off the power supply.”

It is to be noted that the physical memory region in the NAND cell 63 configuring the logical volume 7 may be changed suitably in order to level the number of times of write or the like.

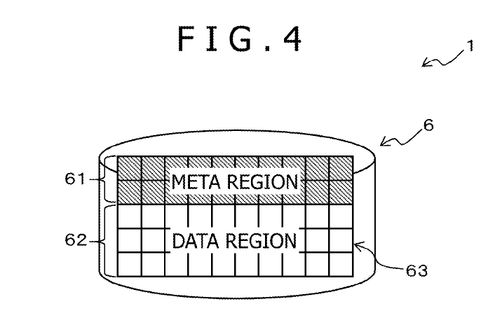

FIG. 4 is a view illustrating a state of use of a flash memory in an SSD as an example of the first embodiment. The flash memory and the SSD described with reference to FIG. 4 may be the flash memory 6 and the SSD 1 described with reference to FIG. 1.

In the present SSD 1, as depicted in FIG. 3, the NAND cell (semiconductor storage region) 63 of the flash memory 6 includes a data power supply block 62 that configures the data region 72 and a meta power supply block 61 that configures the meta region 71.

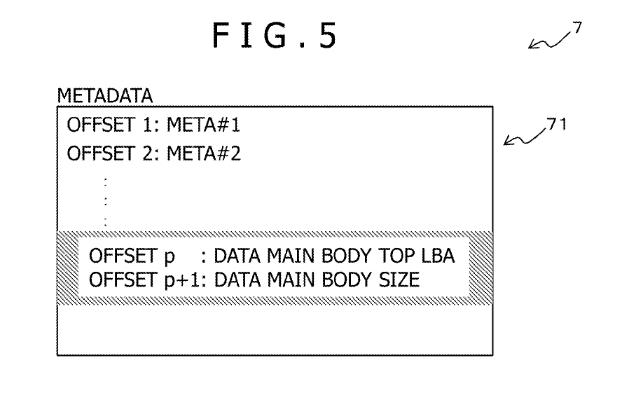

FIG. 5 is a view exemplifying metadata in a logical volume in an SSD as an example of the first embodiment. The logical volume and the SSD described with reference to FIG. 5 may be the logical volume 7 and the SSD 1 described with reference to FIG. 1.

The metadata exemplified in FIG. 5 includes, together with meta#1 and meta#2 that are information on a data main body, a data main body top LBA and a data main body size as logical storage position information.

An FTL 41 hereinafter described generates (converts) position information (physical address information) indicative of the storage position of the data main body in the NAND cell 63 based on the data main body top LBA and the data main body size (logical address information).

Since the metadata includes the data main body top LBA and the data main body size in this manner, the position information of the data main body in the NAND cell 63 is linked to the metadata. In the following description, the data main body top LBA and the data main body size in the metadata are sometimes referred to as NAND link information.

The NAND link information is stored at positions (offsets p and p+1) spaced by a given offset distance from the storage positions of meta#1 and meta#2 (offsets 1 and 2) in the meta region 71 of the logical volume 7.

The host interface 3 is an interface for communicating with an external apparatus of the SSD 1 such as the host apparatus 8 and is configured in compliance with such a standard as non-volatile memory express (NVMe) or serial attached small computer system interface (SAS).

The host interface 3 receives a command (Cmd) or data (DATA) relating to an I/O request transmitted from the host apparatus 8 and performs transmission of read data, various responses and so forth to the host apparatus 8.

The SSD controller 2 performs various kinds of control for the SSD 1. For example, the SSD controller 2 performs transmission or reception of data or various I/O commands to or from the host apparatus 8 through the host interface 3 or controls the memory controller 4 to perform processing of a received I/O command. Upon processing of an I/O command, the SSD controller 2 controls the memory controller 4 to perform reading out or writing of data from or into the NAND cell 63.

Accordingly, the SSD controller 2 functions as a reception section that receives a data access request (extended I/O command with power supply control) including size information of the data main body of an access target from the host apparatus 8.

In the SSD 1 of the present first embodiment, the SSD controller 2 includes an I/O command processing function with power supply control (I/O command processing function with NAND power supply control) for processing an I/O command with power supply control. For example, in the case where the SSD controller 2 receives an I/O command with power supply control from the host apparatus 8, it controls a data access process with power supply control for reducing the power consumption in the NAND cell 63. It is to be noted that the I/O command with NAND power supply control is sometimes referred to as Read/Write command with NAND power supply control.

The SSD controller 2 includes a memory (storage section) not depicted, to which the top position (meta region top LBA: set value 1) of the meta region 71 in the logical volume 7 and the size (meta region size: set value 2) of the meta region 71 are set (stored) as set values in advance. For example, the meta region top LBA=0 and the meta region size=n indicate the storage position of metadata stored in a region (meta region 71) of n Kbytes continuing from the top position (LBA=0) of the logical volume 7.

Further, in the memory of the SSD controller 2, also the size of the metadata (metadata size: set value 3) in the logical volume 7 described above and the offset (link information offset: set value 4) of the storage position of the NAND link information from the top of the metadata are set (stored) as set values. For example, the metadata size=1 Kbyte and the link information offset=p.

It is to be noted that the values (set values 1 to 4) of the meta region top LBA, meta region size, metadata size, and link information offset described above may each be set by a system manager or the like through the host apparatus 8, a management terminal not depicted or the like, or may each be set as prescribed values in advance, and may be carried out in various modified forms.

If the SSD controller 2 receives an I/O command with power supply control (I/O request) from the host apparatus 8, it refers to the metadata included in the I/O request based on the meta region top LBA (set value 1), meta region size (set value 2), metadata size (set value 3), and link information offset (set value 4) set in advance.

For example, the SSD controller 2 specifies the top position of the meta region in the logical volume 7 based on the meta region top LBA (set value 1) and specifies the region of the meta region size (set value 2) continuing from the top position as the meta region 71.

Then, the SSD controller 2 extracts data (metadata) of the metadata size (set value 3) from the meta region 71 and acquires the data main body top LBA and the data main body size indicative of the storage position of the data main body from the position specified by the link information offset (set value 4) in the metadata. For example, the SSD controller 2 acquires the logical storage position of the data main body of the access target from the metadata stored in the meta region 71 of the logical volume 7.

The SSD controller 2 notifies the memory controller 4 of the acquired logical storage position together with an I/O access instruction. The I/O access instruction indicates a read instruction or a write instruction from or into the NAND cell 63 to the memory controller 4 and is generated based on the I/O request received from the host apparatus 8. This I/O access instruction incudes information (for example, a flag) indicating that the I/O access is based on the I/O command with power supply control described above.

The memory controller 4 accesses the physical memory region of the NAND cell 63 based on the I/O access instruction and the logical storage position notified of from the SSD controller 2 to perform write or read of data.

The memory controller 4 is coupled to the host interface 3 as depicted in FIG. 1 such that it receives data transmitted from the host apparatus 8 through the host interface 3 or transmits data read out from the NAND cell 63 to the host apparatus 8 through the host interface 3.

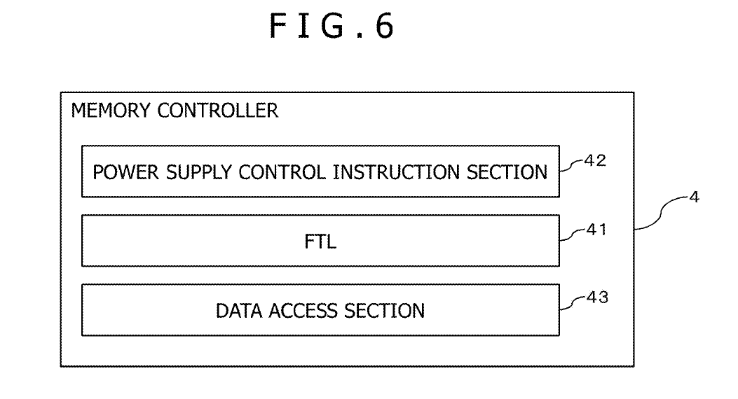

FIG. 6 is a view depicting a functional configuration of a memory controller in an SSD as an example of the first embodiment. The memory controller and the SSD described with reference to FIG. 6 may be the memory controller 4 and the SSD 1 described with reference to FIG. 1.

As depicted in FIG. 6, the memory controller 4 includes an FTL 41, a power supply control instruction section 42, and a data access section 43.

The FTL 41 includes a conversion function for converting a logical storage position into a physical storage position and convers a logical storage position in the logical volume 7 notified of from the SSD controller 2 into a physical storage position in the NAND cell 63. The physical storage position signifies a position in the NAND cell 63 at which data access occurs by an I/O request from the host apparatus 8.

The FTL 41 specifies, based on the position information (logical storage position information; data main body top LBA and data main body length) included in the metadata, the storage position (physical storage position) of the data main body of the access target in the NAND cell 63. Further, the FTL 41 functions as an access position confirmation section that confirms the access position in the NAND cell 63.

The data access section 43 performs data access for the NAND cell 63, for example, read access or write access. The data access section 43 performs data access for the NAND cell 63 based on the physical storage position converted by the FTL 41.

In the case where a write request is issued from the host apparatus 8, the SSD controller 2 notifies the memory controller 4 of an I/O access instruction indicative of a write request and a logical storage position indicative of a write destination position.

The data access section 43 acquires a physical storage position converted from the logical storage position by the FTL 41 and acquires write data received from the host apparatus 8 through the host interface 3. Then, the data access section 43 writes the write data into a position in the NAND cell 63 specified by the physical storage position.

On the other hand, in the case where a read request is issued from the host apparatus 8, the SSD controller 2 notifies the memory controller 4 of an I/O access instruction indicative of a read request and a logical storage position indicative of a read position.

The data access section 43 acquires a physical storage position converted from the logical storage position by the FTL 41 and reads out data (read data) from a position specified by the physical storage position in the NAND cell 63. Then, the memory controller 4 causes the read data to be sent out to the host apparatus 8 through the host interface 3.

The power supply control instruction section 42 issues an instruction to the memory power supply controller 5 to turn on the power supply to a power supply block 601 of a data access destination in the NAND cell 63. The power supply control instruction section 42 functions in a data access process with power supply control for reducing the power consumption.

The power supply control instruction section 42 issues an instruction for power supply to the memory power supply controller 5. For example, the power supply control instruction section 42 instructs the memory power supply controller 5 to turn on the power supply to the power supply block 601 that includes a data access destination position by the data access section 43.

The power supply control instruction section 42 issues an instruction to the memory power supply controller 5 to normally perform supply of power to the meta power supply block 61 in the NAND cell 63.

On the other hand, when the present SSD 1 is in an idle state, the power supply control instruction section 42 basically causes the power supply to the data power supply block 62 in the NAND cell 63 to keep an off state (powered off normally).

Then, when data access to the data region 72 occurs, the power supply control instruction section 42 issues an instruction to the memory power supply controller 5 to turn on the power supply to the power supply block 601 that includes the access destination position to which data access by the data access section 43 is performed. For example, in the data region 72 of the NAND cell 63, power supply is performed temporarily only to the power supply block 601 corresponding to the access. In this manner, before data access to the NAND cell 63 by the data access section 43, the power supply control instruction section 42 causes the power supply to the power supply block 601 including the data access destination to change from a power supply off state to a power supply on state.

Further, after the power supply control instruction section 42 performs a process (read/write) based on an I/O access instruction from the SSD controller 2 for the NAND cell 63, it issues an instruction to the memory power supply controller 5 to turn off the power supply to the power supply block 601 of the data access destination for which the data access process has been performed in the NAND cell 63.

(B) Operation [Read Process]

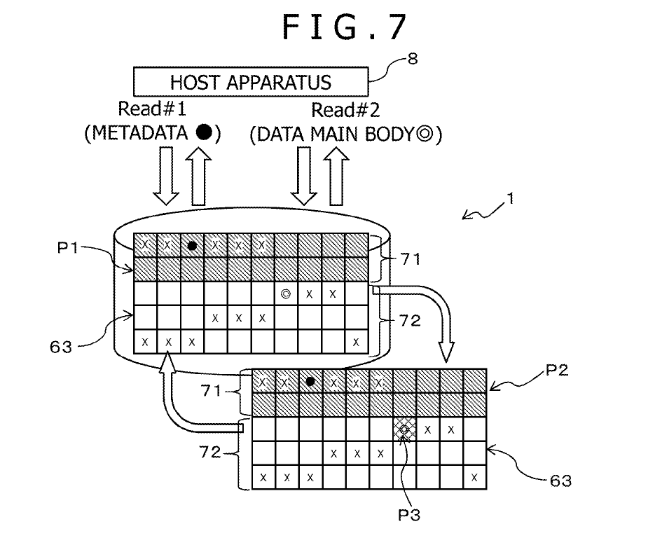

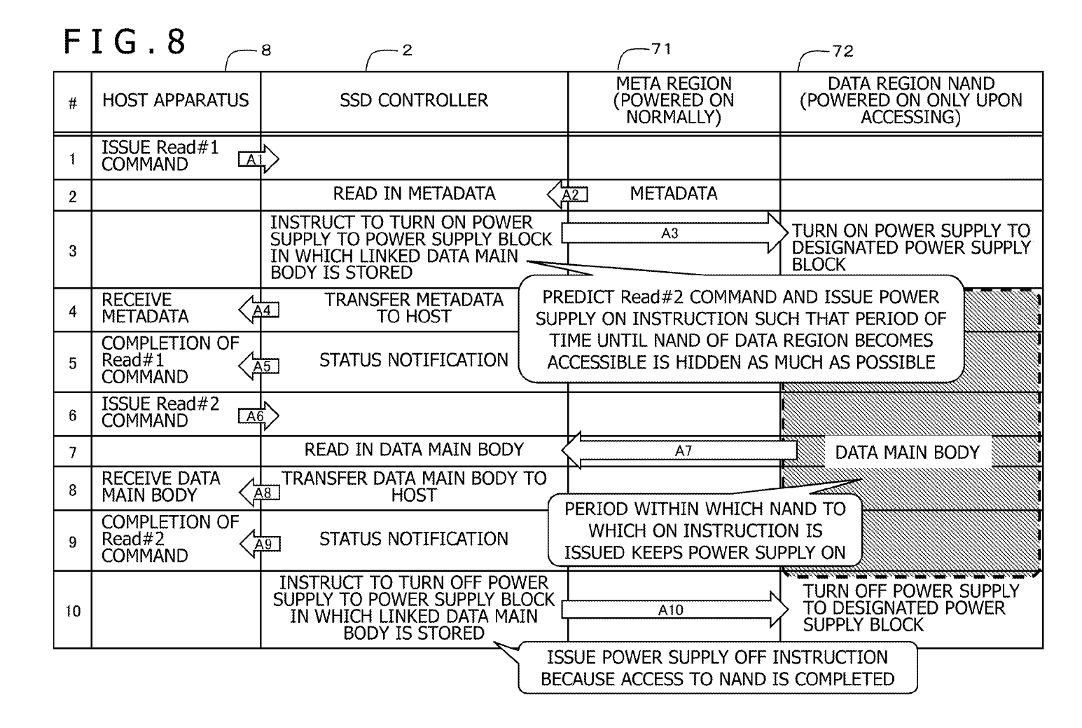

A read process in an SSD as an example of the first embodiment configured in such a manner as described above is described in accordance with a sequence diagram depicted in FIG. 8 with reference to FIG. 7. It is to be noted that FIG. 7 is a view illustrating transition of a power supply state of a NAND cell in a read process of an SSD as an example of the first embodiment. The NAND cell and the SSD described with reference to FIG. 7 and FIG. 8 may be the NAND cell 63 and the SSD 1 described with reference to FIG. 1.

Referring to FIG. 7, an arrow mark P1 denotes a power supply state of the NAND cell 63 before data access occurs and another arrow mark P2 denotes a power supply state when data access occurs.

In FIG. 7, each rectangle in the NAND cell 63 denotes a power supply block 601, and a portion indicated by slanting lines denotes a meta region 71 while a blank portion denotes a data region 72. Further, a double circle (⊚) denotes a data main body of a processing target of an I/O command with power supply control for read from the host apparatus 8, and a black circle (•) denotes metadata of the I/O command with power supply control.

For example, from among data, the metadata is stored in the meta region 71, and the data main body is stored in the data region 72. Furthermore, a cross mark (x) denotes a position at which some data (data main body) is stored. Meanwhile, a rectangle in which none of a black circle (•), a double circle (⊚) and a cross mark (x) is applied indicates an unused region.

Further, in FIG. 8, the item denoted by # at the left end indicates a step number.

In a state in which data access from the host apparatus 8 to the SSD 1 does not occur, the memory power supply controller 5 controls all power supply blocks 601 of the meta region 71 to a power supply on state and controls the power supply blocks 601 of the data region 72 to a power supply off state as indicated by the arrow mark P1.

At step 1, in order to read metadata (•), the host apparatus 8 issues an I/O command with power supply control for read (Read#1 command) to the SSD controller 2 (refer to an arrow mark A1 of FIG. 8).

At step 2, the SSD controller 2 instructs the data access section 43 to read out the metadata (•) from the power supply blocks 601 of the meta region 71, which are in a power supply on state (refer to an arrow mark A2 of FIG. 8).

At step S3, the SSD controller 2 refers to the read out metadata to acquire a reading out position (logical storage position) of the data main body linked to the metadata. Then, the SSD controller 2 instructs the memory controller 4 (power supply control instruction section 42) to turn on the power supply to the power supply blocks 601 (refer to an arrow mark P3 of FIG. 7) including the physical storage position corresponding to the reading out position (logical storage position) of data in the NAND cell 63 (refer to the arrow mark P2 in FIG. 7 and an arrow mark A3 in FIG. 8).

For example, the SSD controller 2 instructs the memory controller 4 (power supply control instruction section 42) to turn on the power supply to the power supply block 601 in which the data main body (⊚) linked to the metadata is stored. The power supply control instruction section 42 turns on the power supply to the designated power supply block 601 in accordance with the instruction.

In the present SSD 1, predicting a Read#2 command (hereinafter described) that involves data access to the data region 72, which is to be issued following the Read#1 command, the power supply to the corresponding power supply block 601 is turned on. Consequently, the influence of the period of time (time lag) until the NAND of the data region 72 that has been in the power supply off state becomes accessible may be reduced.

At step 4, the SSD controller 2 instructs the memory controller 4 to transfer the metadata to the host apparatus 8 (refer to an arrow mark A4 in FIG. 8), and the host apparatus 8 receives the metadata.

At step 5, the SSD controller 2 issues a status notification that metadata has been transmitted to the host apparatus 8 (refer to an arrow mark A5 of FIG. 8). The process of the Read#1 command in the host apparatus 8 is completed therewith.

At step 6, the host apparatus 8 issues an I/O command with power supply control for read (Read#2 command) to the SSD controller 2 in order to read out the data main body (⊚) linked to the metadata (refer to an arrow mark A6 of FIG. 8).

At step 7, the SSD controller 2 instructs the memory controller 4 (data access section 43) to read out the data main body (⊚) from the storage position of the data main body in the NAND cell 63 to which the power supply is on (refer to an arrow mark A7 of FIG. 8).

At step 8, the SSD controller 2 instructs the memory controller 4 to transfer the data main body to the host apparatus 8 (refer to an arrow mark A8 of FIG. 8), and the host apparatus 8 receives the data main body.

At step 9, the SSD controller 2 issues a status notification that the data main body has been transmitted to the host apparatus 8 (refer to an arrow mark A9 of FIG. 8). The process of the Read#2 command in the host apparatus 8 is completed therewith.

After the transfer of the data main body (⊚) to the host apparatus 8 is completed, at step 10, the SSD controller 2 instructs the memory controller 4 (power supply control instruction section 42) to turn off the power supply to the power supply block 601 (refer to the arrow mark P3 in FIG. 7) in which the data main body (⊚) linked to the metadata is stored (refer to an arrow mark A10 of FIG. 8). The power supply control instruction section 42 turns off the power supply to the designated power supply block 601 in accordance with the instruction.

[Write Process]

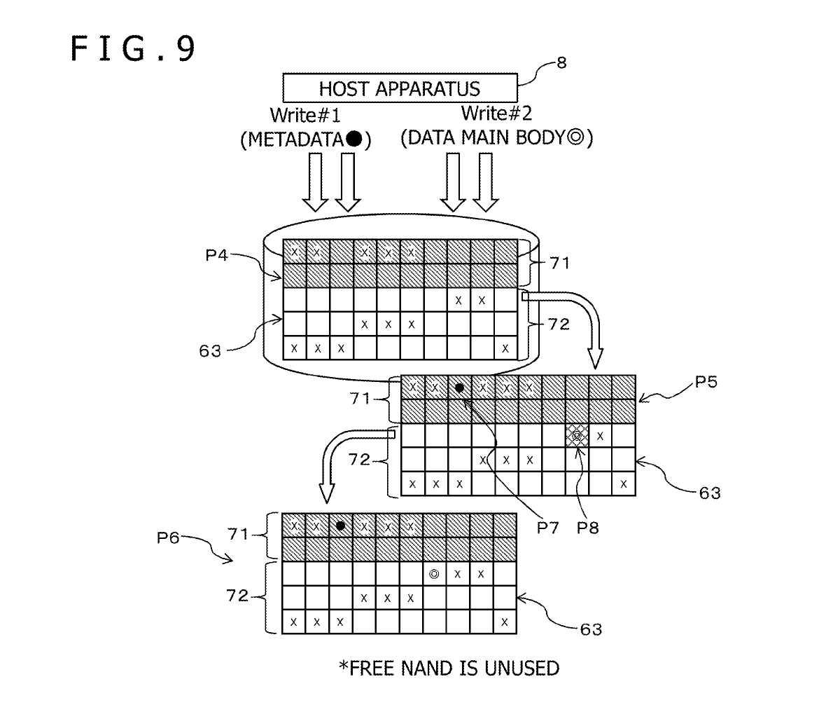

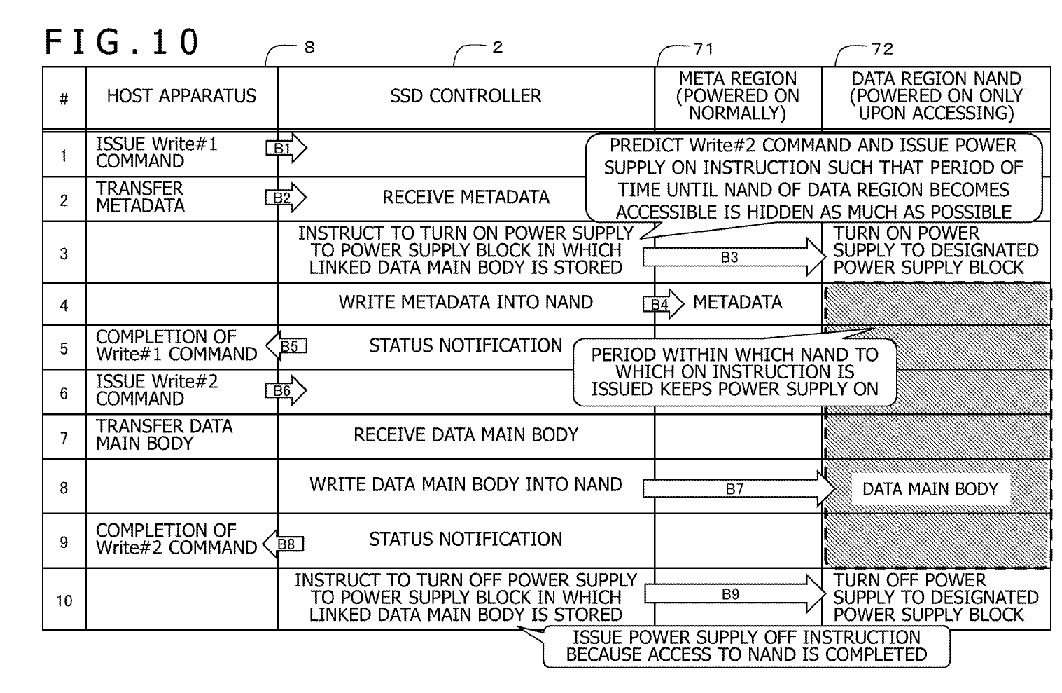

Now, a write process in an SSD as an example of the first embodiment configured in such a manner as described above is described in accordance with a sequence diagram depicted in FIG. 10 with reference to FIG. 9. It is to be noted that FIG. 9 is a view illustrating transition of a power supply state of a NAND cell in a write process of an SSD as an example of the first embodiment. The NAND cell and the SSD described with reference to FIG. 9 and FIG. 10 may be the NAND cell 63 and the SSD 1 described with reference to FIG. 1.

Referring to FIG. 9, an arrow mark P4 denotes a power supply state of the NAND cell 63 before write data access occurs, and another arrow mark P5 denotes a power supply state after write data access occurs. Meanwhile, a further arrow mark P6 denotes a power supply state after the write data access.

In FIG. 9, each rectangle in the NAND cell 63 denotes a power supply block 601, and a portion indicated by slanting lines denotes a meta region 71 while a blank portion denotes a data region 72. Further, a double circle (⊚) denotes a data main body of a processing target of an I/O command with power supply control for read from the host apparatus 8, and a black circle (•) denotes metadata of the I/O command with power supply control.

For example, from among data, the metadata is stored in the meta region 71, and the data main body is stored in the data region 72. Furthermore, a cross mark (x) denotes a position at which some data (data main body) is stored. Meanwhile, a rectangle in which none of a black circle (•), a double circle (⊚) and a cross mark (x) is applied indicates an unused region.

Further, in FIG. 10, the item denoted by # at the left end indicates a step number.

In a state in which data access from the host apparatus 8 to the SSD 1 does not occur, the memory power supply controller 5 controls all power supply blocks 601 of the meta region 71 to a power supply on state and controls the power supply blocks 601 of the data region 72 to a power supply off state as indicated by the arrow mark P4 in FIG. 9.

At step 1, in order to write metadata (•), the host apparatus 8 issues an I/O command with power supply control for write (Write#1 command) to the SSD controller 2 (refer to an arrow mark B1 of FIG. 10).

At step 2, the host apparatus 8 transfers metadata relating to the Write#1 command to the SSD controller 2, and the SSD controller 2 receives the metadata (refer to an arrow mark B2 in FIG. 10).

At step 3, the SSD controller 2 refers to the received metadata to acquire a write destination position (logical storage position) of the data main body linked to the metadata. Then, the SSD controller 2 instructs the memory controller 4 (power supply control instruction section 42) to turn on the power supply to the power supply block 601 (refer to an arrow mark P8 in FIG. 9) that includes a physical storage position corresponding to the write destination position (logical storage position) of data in the NAND cell 63 (refer to the arrow mark P5 in FIG. 9 and an arrow mark B3 in FIG. 10). The power supply control instruction section 42 turns on the power supply to the designated power supply block 601 in accordance with the instruction.

In the present SSD 1, predicting a Write#2 command (hereinafter described) that involves data access to the data region 72, which is to be issued following the Write#1 command, the power supply to the corresponding power supply block 601 is turned on. Consequently, the influence of the period of time (time lag) until the NAND of the data region 72 that has been in the power supply off state becomes accessible may be reduced.

At step 4, the SSD controller 2 instructs the memory controller 4 (data access section 43) to write the metadata into a write target position in the NAND cell 63 (refer to an arrow mark P7 in FIG. 9 and an arrow mark B4 in FIG. 10).

At step 5, the SSD controller 2 issues a status notification that the metadata has been written in the NAND cell 63 to the host apparatus 8 (refer to an arrow mark B5 in FIG. 10). The process of the Write#1 command in the host apparatus 8 is completed therewith.

At step 6, the host apparatus 8 issues a Write#2 command to the SSD controller 2 (refer to an arrow mark B6 in FIG. 10).

At step 7, the host apparatus 8 transfers to the SSD 1 the data main body to be written into the SSD 1, and the SSD controller 2 receives this data main body.

At step S8, the SSD controller 2 instructs the memory controller 4 (data access section 43) to write the data main body (⊚) into a write destination position in the NAND cell 63 to which the power supply is on (refer to the arrow mark P8 in FIG. 9 and an arrow mark B7 in FIG. 10).

At step 9, the SSD controller 2 issues a status notification that write of the data main body has been performed to the host apparatus 8 (refer to an arrow mark B8 in FIG. 10). The process of the Write#2 command in the host apparatus 8 is completed therewith.

After the status notification to the host apparatus 8 is completed, at step 10, the SSD controller 2 instructs the memory controller 4 (power supply control instruction section 42) to turn off the power supply to the power supply block 601 (refer to the arrow mark P8 in FIG. 9) in which the data main body (⊚) linked to the metadata is stored (refer to an arrow mark B9 in FIG. 10). The power supply control instruction section 42 turns off the power supply to the designated power supply block 601 in accordance with the instruction (refer to the arrow mark P6 in FIG. 9).

(C) Effects

In this manner, with the SSD 1 as the example of the first embodiment of the present technology, when data access to the NAND cell 63 is not performed, the power supply to the data region 72 of the NAND cell 63 is kept off. Then, when data access to the NAND cell 63 occurs, the power supply only to the power supply block 601 that includes an access target position is turned on, and the power consumption may be reduced thereby.

Further, since the power supply to the meta region 71 of the NAND cell 63 is normally kept on, there is no influence on access to metadata, and the performance degradation does not occur.

Further, metadata includes NAND link information indicative of a storage position of a data main body in the logical volume 7 such that, if data access to the metadata is performed, the data main body may be accessed rapidly by referring to the NAND link information.

Furthermore, if data access to the NAND link information is performed, the power supply to the power supply block 601 that includes a physical storage position in the NAND cell 63 specified by the NAND link information is turned on. For example, data access to the data region 72 is predicted based on data access to metadata, and the power supply to the corresponding power supply block 601 is turned on. Consequently, the influence of the period of time (time lag) until the NAND of the data region 72 becomes accessible may be reduced.

Further, for example, by suitably changing the size of the meta region 71, the power consumption in an idle state may be set in accordance with system specifications.

By using an I/O command with power supply control, while an upper layer such as the host apparatus 8 is not conscious of the NAND cell 63, the power supply to the power supply blocks 601 of the NAND cell 63 may be controlled between on and off.

### (II) Description of Second Embodiment

(A) Configuration

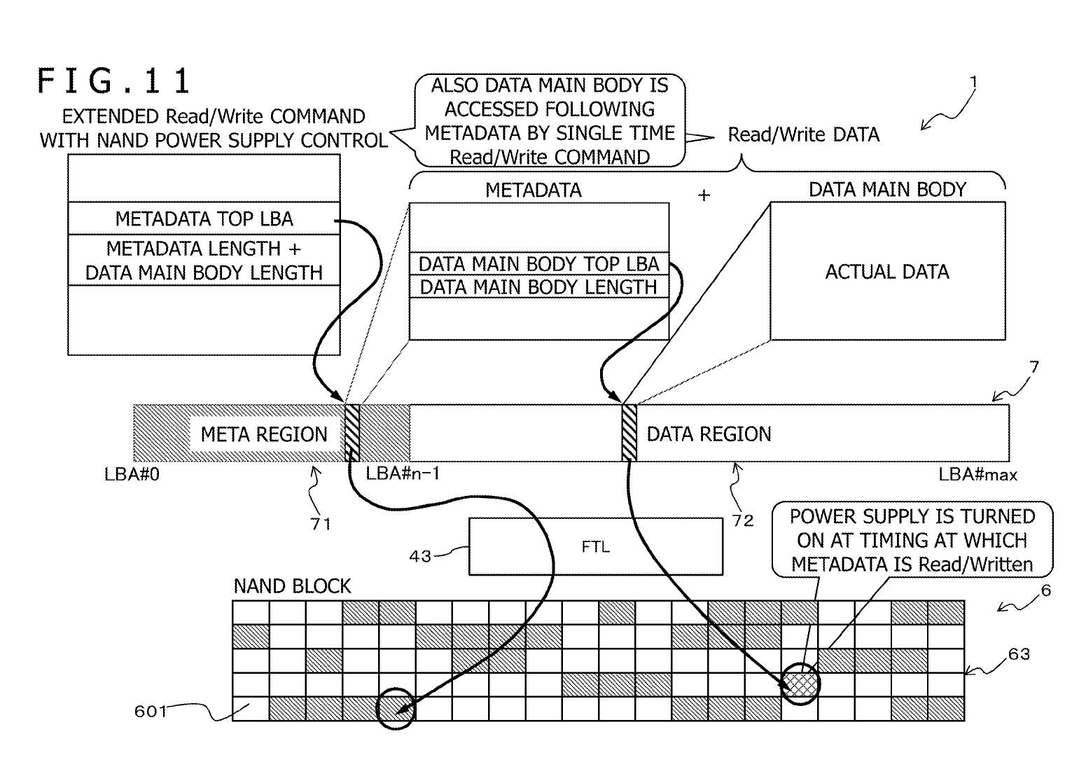

FIG. 11 is a view depicting an overview of processing upon data accessing in an SSD as an example of a second embodiment of the present technology. The SSD described with reference to FIG. 11 may be the SSD 1 described with reference to FIG. 1.

In the second embodiment, an I/O command with power supply control transmitted from the host apparatus 8 to the SSD 1 includes information of a size of the data main body (data main body length) of an access target.

In the following description, an I/O command with power supply control including a data main body length in the second embodiment is sometimes referred to as extended I/O command with power supply control.

Further, in the SSD 1 of the second embodiment, the SSD controller 2 includes a processing function for an extended I/O command with power supply control (processing function for an extended I/O command with NAND power supply control) for processing an extended I/O command with power supply control. For example, in the case the SSD controller 2 receives an extended I/O command with power supply control from the host apparatus 8, it performs a data access process that involves power supply control for reducing the power consumption for the NAND cell 63. It is to be noted that an extended I/O command with NAND power supply control is sometimes referred to as extended Read/Write command with NAND power supply control.

Referring to FIG. 11, the extended I/O command with NAND power supply control includes a “metadata length+data main body length” in addition to a “metadata top LBA,” and the SSD controller 2 uses the information to perform data access to the NAND cell 63. It is to be noted that the “metadata length+data main body length” may be provided as a single value that is a sum of the value of the “metadata length” and the value of the “data main body length.”

In the SSD 1 of the second embodiment, the SSD controller 2 of the first embodiment includes a processing function for an extended I/O command with power supply control, and the other part of the SSD 1 is configured similarly to that of the SSD 1 of the first embodiment.

It is to be noted that, in FIG. 11, same reference symbols as those mentioned hereinabove denote like elements and description of them is omitted.

The SSD controller 2 implements access to the data main body following the metadata by an I/O command issued once by referring to the extended I/O command with power supply control.

(B) Operation

[Read Process]

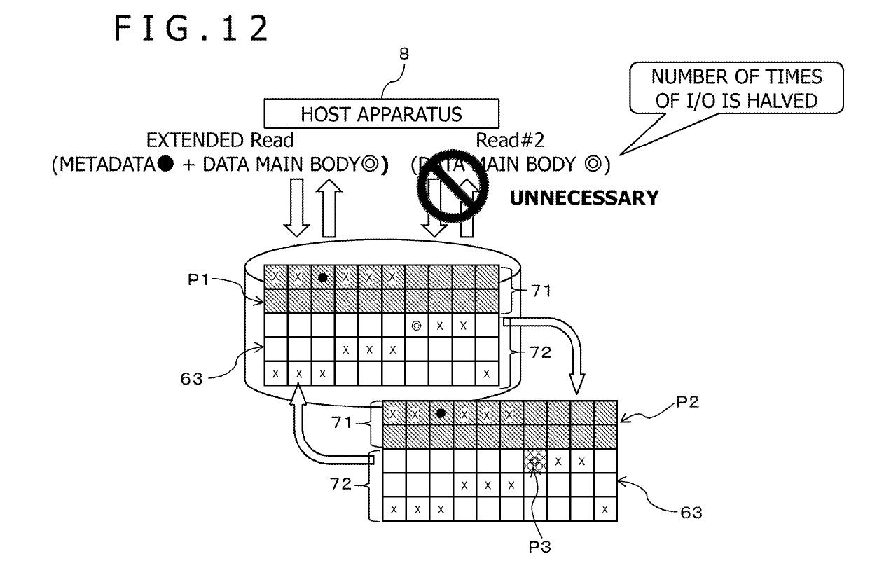

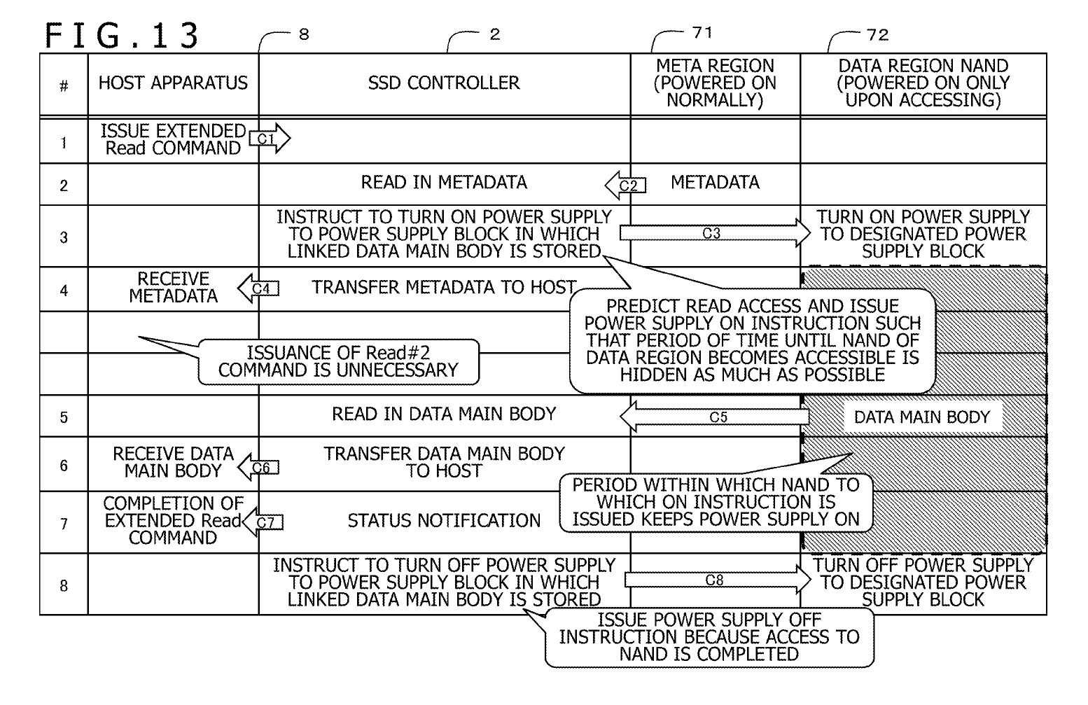

A read process in an SSD as an example of the second embodiment is described in accordance with a sequence diagram depicted in FIG. 13 with reference to FIG. 12. It is to be noted that FIG. 12 is a view illustrating transition of a power supply state of a NAND cell in a read process of an SSD as an example of the second embodiment. The NAND cell and the SSD described with reference to FIG. 12 and FIG. 13 may be the NAND cell 63 and the SSD 1 described with reference to FIG. 1.

Referring to FIG. 12, an arrow mark P1 denotes a power supply state of the NAND cell 63 before data access occurs and another arrow mark P2 denotes a power supply state when data access occurs.

In FIG. 12, each rectangle in the NAND cell 63 denotes a power supply block 601, and a portion indicated by slanting lines denotes a meta region 71 while a blank portion denotes a data region 72. Further, a double circle (⊚) denotes a data main body of a processing target of an I/O command with power supply control for read from the host apparatus 8, and a black circle (•) denotes metadata of the I/O command with power supply control.

For example, from among data, the metadata is stored in the meta region 71, and the data main body is stored in the data region 72. Furthermore, a cross mark (x) denotes a position at which some data (data main body) is stored. Meanwhile, a rectangle in which none of a black circle (•), a double circle (⊚) and a cross mark (x) is applied indicates an unused region.

Further, in FIG. 13, the item denoted by # at the left end indicates a step number.

In a state in which data access from the host apparatus 8 to the SSD 1 does not occur, the memory power supply controller 5 controls all power supply blocks 601 of the meta region 71 to a power supply on state and controls the power supply blocks 601 of the data region 72 to a power supply off state as indicated by the arrow mark P1.

At step 1, in order to read metadata (•), the host apparatus 8 issues an extended I/O command with power supply control for read (hereinafter referred to as extended Read command) to the SSD controller 2 (refer to an arrow mark C1 of FIG. 13).

At step 2, the SSD controller 2 instructs the data access section 43 to read out the metadata (•) from the power supply blocks 601 of the meta region 71, which are in a power supply on state (refer to an arrow mark C2 of FIG. 13).

At step 3, the SSD controller 2 refers to the read out metadata to acquire a reading out position (logical storage position) of the data main body linked to the metadata. Then, the SSD controller 2 instructs the memory controller 4 (power supply control instruction section 42) to turn on the power supply to the power supply block 601 (refer to an arrow mark P3 in FIG. 12) that includes a physical storage position corresponding to the reading out position (logical storage position) of data in the NAND cell 63 (refer to the arrow mark P2 in FIG. 12 and an arrow mark C3 in FIG. 13).

For example, the SSD controller 2 instructs the memory controller 4 (power supply control instruction section 42) to turn on the power supply to the power supply block 601 in which the data main body (⊚) linked to the metadata is stored. The power supply control instruction section 42 turns on the power supply to the designated power supply block 601 in accordance with the instruction.

In the present SSD 1, predicting data access to the data region 72 that is to be performed after access to metadata based on the extended Read command, the power supply to the corresponding power supply block 601 is turned on. Consequently, the influence of the period of time (time lag) until the NAND of the data region 72 that has been in the power supply off state becomes accessible may be reduced.

At step 4, the SSD controller 2 instructs the memory controller 4 to transfer the metadata to the host apparatus 8 (refer to an arrow mark C4 in FIG. 13), and the host apparatus 8 receives the metadata.

At step 5, the SSD controller 2 instructs the memory controller 4 (data access section 43) to read out the data main body (⊚) from the storage position of the data main body in the NAND cell 63 to which the power supply is on (refer to an arrow mark C5 in FIG. 13).

The SSD controller 2 has acquired the data main body length from the extended Read command (extended I/O command with power supply control) transmitted from the host apparatus 8. Therefore, the SSD controller 2 may instruct the data access section 43 to perform read access to the NAND cell 63 without receiving the Read#2 command from the host apparatus 8.

For example, the SSD 1 of the second embodiment may perform a read process for the NAND cell 63 in response to single time reception of an I/O command for read (extended Read command) from the host apparatus 8.

At step 6, the SSD controller 2 instructs the memory controller 4 to transfer the data main body to the host apparatus 8 (refer to an arrow mark C6 of FIG. 13), and the host apparatus 8 receives this data main body.

At step 7, the SSD controller 2 issues a status notification that the data main body has been transmitted to the host apparatus 8 (refer to an arrow mark C7 In FIG. 13). The process of the extended Read command in the host apparatus 8 is completed therewith.

After the transfer of the data main body (⊚) to the host apparatus 8 is completed, at step 8, the SSD controller 2 instructs the memory controller 4 (power supply control instruction section 42) to turn off the power supply to the power supply block 601 (refer to the arrow mark P3 in FIG. 12) in which the data main body (⊚) linked to the metadata is stored (refer to an arrow mark C8 of FIG. 13). The power supply control instruction section 42 turns off the power supply to the designated power supply block 601 in accordance with the instruction.

[Write Process]

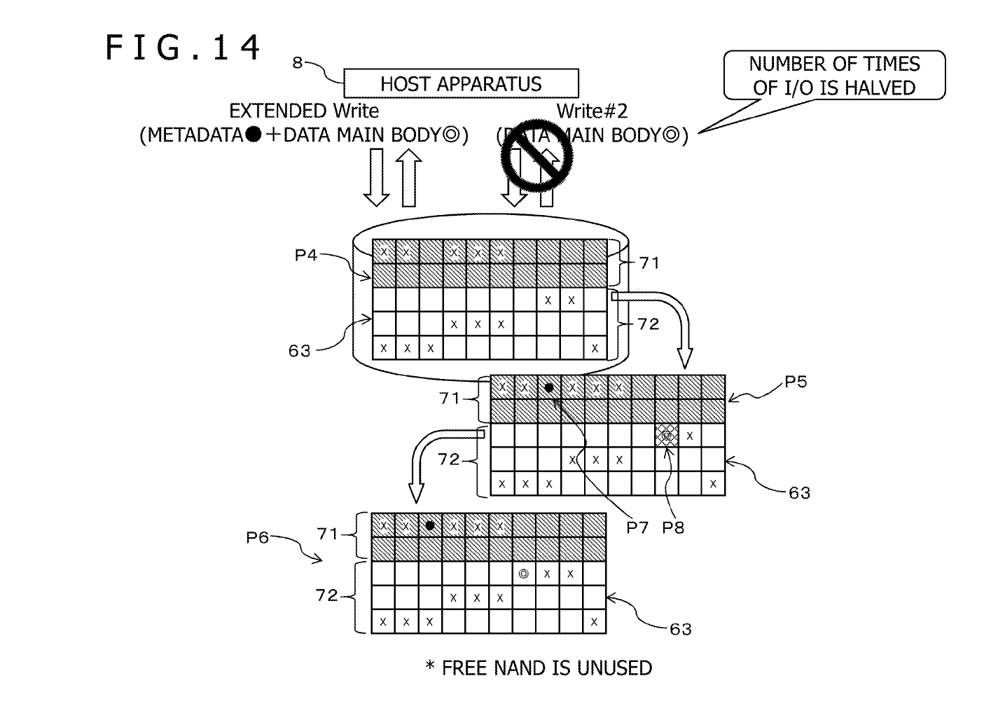

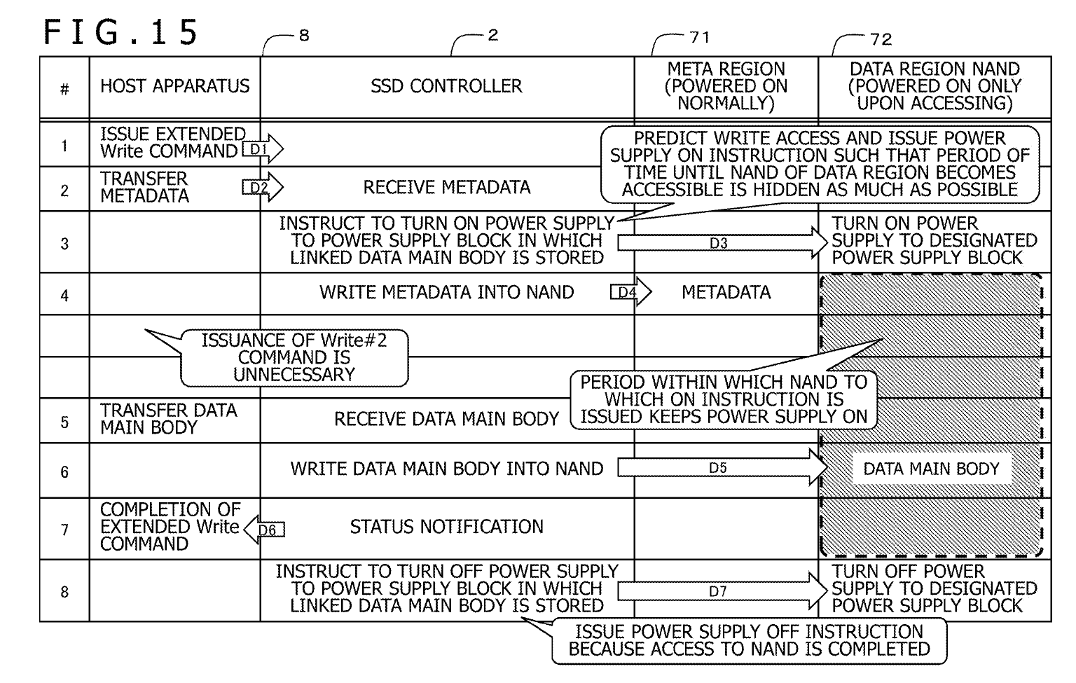

A write process in an SSD as an example of the second embodiment is described in accordance with a sequence diagram depicted in FIG. 15 with reference to FIG. 14. It is to be noted that FIG. 14 is a view illustrating transition of a power supply state of a NAND cell in a write process of an SSD as an example of the second embodiment. The NAND cell and the SSD described with reference to FIG. 14 and FIG. 15 may be the NAND cell 63 and the SSD 1 described with reference to FIG. 1.

Referring to FIG. 14, an arrow mark P4 denotes a power supply state of the NAND cell 63 before write data access occurs and another arrow mark P5 denotes a power supply state after write data access occurs. Further, a further arrow mark P6 denotes a power supply state after the write data access.

In FIG. 14, each rectangle in the NAND cell 63 denotes a power supply block 601, and a portion indicated by slanting lines denotes a meta region 71 while a blank portion denotes a data region 72. Further, a double circle (⊚) denotes a data main body of a processing target of an I/O command with power supply control for read from the host apparatus 8, and a black circle (•) denotes metadata of the I/O command with power supply control.

For example, from among data, the metadata is stored in the meta region 71, and the data main body is stored in the data region 72. Furthermore, a cross mark (x) denotes a position at which some data (data main body) is stored. Meanwhile, a rectangle in which none of a black circle (•), a double circle (⊚) and a cross mark (x) is applied indicates an unused region.

Further, in FIG. 15, the item denoted by # at the left end indicates a step number.

In a state in which data access from the host apparatus 8 to the SSD 1 does not occur, the memory power supply controller 5 controls all power supply blocks 601 of the meta region 71 to a power supply on state and controls the power supply blocks 601 of the data region 72 to a power supply off state as indicated by the arrow mark P4 in FIG. 14.

At step 1, in order to write metadata (•), the host apparatus 8 issues an extended I/O command with power supply control for write (extended Write command) to the SSD controller 2 (refer to an arrow mark D1 of FIG. 15).

At step 2, the host apparatus 8 transfers metadata relating to the extended Write command to the SSD controller 2, and the SSD controller 2 receives the metadata (refer to an arrow mark D2 in FIG. 15).

At step 3, the SSD controller 2 refers to the received metadata to acquire a write destination position (logical storage position) of the data main body linked to the metadata. Then, the SSD controller 2 instructs the memory controller 4 (power supply control instruction section 42) to turn on the power supply to the power supply block 601 (refer to an arrow mark P8 in FIG. 14) that includes a physical storage position corresponding to the write destination position (logical storage position) of data in the NAND cell 63 (refer to the arrow mark P5 in FIG. 14 and an arrow mark D3 in FIG. 15). The power supply control instruction section 42 turns on the power supply to the designated power supply block 601 in accordance with the instruction.

In the present SSD 1, predicting data access to the data region 72 that is to be performed after access to metadata based on the extended Write command, the power supply to the corresponding power supply block 601 is turned on. Consequently, the influence of the period of time (time lag) until the NAND of the data region 72 that has been in the power supply off state becomes accessible may be reduced.

At step S4, the SSD controller 2 instructs the memory controller 4 (data access section 43) to write the metadata into the write target position in the NAND cell 63 (refer to an arrow mark P7 in FIG. 14 and an arrow mark D4 in FIG. 15).

The SSD controller 2 has acquired the data main body length from the extended Write command (extended I/O command with power supply control) transmitted from the host apparatus 8. Therefore, the SSD controller 2 may instruct the data access section 43 to perform write access to the NAND cell 63 without receiving the Write#2 command from the host apparatus 8.

For example, the SSD 1 of the present second embodiment may perform a write process for the NAND cell 63 in response to single time reception of an I/O command for write (extended Write command) from the host apparatus 8.

At step 5, the host apparatus 8 transfers to the SSD 1 the data main body to be written into the SSD 1, and the SSD controller 2 receives this data main body.

At step 6, the SSD controller 2 instructs the memory controller 4 (data access section 43) to write the data main body (⊚) into the write destination position in the NAND cell 63 to which the power supply is on (refer to the arrow mark P8 in FIG. 14 and an arrow mark D5 in FIG. 15).

At step 7, the SSD controller 2 issues a status notification that the data main body has been written to the host apparatus 8 (refer to an arrow mark D6 in FIG. 15). The process of the extended Write command in the host apparatus 8 is completed therewith.

After the status notification to the host apparatus 8 is completed, at step 8, the SSD controller 2 instructs the memory controller 4 (power supply control instruction section 42) to turn off the power supply to the power supply block 601 (refer to the arrow mark P8 in FIG. 14) in which the data main body (⊚) linked to the metadata is stored (refer to an arrow mark D7 of FIG. 15). The power supply control instruction section 42 turns off the power supply to the designated power supply block 601 in accordance with the instruction (refer to the arrow mark P6 in FIG. 14).

(C) Effects

In this manner, with the SSD 1 as the second embodiment of the present technology, working effects similar to those achieved by the first embodiment described hereinabove may be achieved. Further, a read process or a write process for the NAND cell 63 may be performed by single time reception of an I/O command (extended Read command or extended Write command) from the host apparatus 8.

Further, this may reduce the number of times of data communication between the host apparatus 8 and the SSD 1 and so forth and reduce the overhead of I/O processing.

### (III) Others

The embodiment discussed herein is not limited to the embodiments described hereinabove and may be carried out in various modified forms without departing from the spirit and scope of the present technology.

For example, while the embodiments described hereinabove exemplify an example in which the flash memory 6 is a NAND type flash memory, the flash memory 6 is not limited to this. For example, even if a NOR type flash memory is applied, the embodiments discussed herein may be carried out in various modified forms.

Further, the embodiments discussed herein may be carried out and produced by those skilled in the art based on the disclosure given hereinabove.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A storage apparatus comprising:
a memory configured to store target data including a data main body and management information relating to the data main body;
a memory power-supply controller configured to control on and off of power supply to the memory in units of a power-supply block that is a memory block for storing a piece of data included in the data main body or included in the management information; and
a memory controller configured to cause the memory power-supply controller to:
turn off power supply to a plurality of power-supply blocks in the memory, each of which stores a piece of data included in the data main body, and
when a first access to the management information stored in the memory occurs, turn on power supply to a first power-supply block of the plurality of power-supply blocks in the memory, based on position information included in the management information, the first power-supply block being a memory block that stores a piece of data included in the data main body which is to be accessed in connection with the first access.

2. The storage apparatus of claim 1, wherein
the memory power-supply controller is configured to keep power supply to one or more power-supply blocks each of which stores the management information, among the plurality of power-supply blocks in the memory.

3. The storage apparatus of claim 1, wherein
the memory controller is configured to:
receive, from an external information processing apparatus, a data access request including size information of the data main body to be accessed, and
perform a data access to a range in the data main body which is specified using the size information.

4. A method to control a storage apparatus including a memory configured to store target data including a data main body and management information relating to the data main body, the method comprising:
controlling on and off of power supply to the memory in units of a power-supply block that is a memory block for storing a piece of data included in the data main body or included in the management information;
turning off power supply to a plurality of power-supply blocks in the memory, each of which stores a piece of data included in the data main body; and
when a first access to the management information stored in the memory occurs, turning on power supply to a first power-supply block of the plurality of power-supply blocks in the memory, based on position information included in the management information, the first power-supply block being a memory block that stores a piece of data included in the data main body which is to be accessed in connection with the first access.

5. The method of claim 4, further comprising
keeping power supply to one or more power-supply blocks each of which stores the management information, among the plurality of power-supply blocks in the memory.

6. The method of claim 4, further comprising
receiving, from an external information processing apparatus, a data access request including size information of the data main body to be accessed; and
performing data access to a range in the data main body which is specified using the size information.
